(19) United States
(12) Patent Application Publication
(10) Pub. No.: US 2025/0210244 A1
(43) Pub. Date: Jun. 26, 2025

(54) WIRELESS POWER SUPPLY DEVICE FOR SWITCH DRIVING OF MEDIUM VOLTAGE SYSTEM AND METHOD OF MANUFACTURING THE SAME

(71) Applicant: University of Seoul Industry Cooperation Foundation, Seoul (KR)

(72) Inventors: Seung Hwan LEE, Seoul (KR); Jae Hong LEE, Seoul (KR)

(21) Appl. No.: 18/977,551

(22) Filed: Dec. 11, 2024

(30) Foreign Application Priority Data
Dec. 20, 2023 (KR) 10-2023-0187688

(51) Int. Cl. H01F 27/28; H02J 50/12; H02J 50/70

(52) U.S. Cl. CPC H01F 27/28; H02J 50/12; H02J 50/70

(57) ABSTRACT

The present disclosure relates to a wireless power supply device for switch driving of a medium voltage system, and a method of manufacturing the same, and more specifically, the device may include a high frequency conversion unit for converting input power into AC power; a feed coil connected to the high frequency conversion unit to generate AC power into an AC magnetic field; a first insulating structure surrounding the feed coil; a collector coil spaced apart from the feed coil by a predetermined distance to generate AC power by an AC magnetic field radiated from the feed coil; a second insulating structure surrounding the collector coil; and a power conversion unit connected to the collector coil to rectify and convert AC power into DC power.

### BACKGROUND OF THE INVENTIVE CONCEPT

### Field of the Inventive Concept

The present disclosure relates to a wireless power supply device for switch driving of a medium voltage system capable of supplying insulated power required for switch driving of a 25 kV medium voltage system by securing a high insulation strength at a medium voltage, that is, a level of 70 kV, by using a feed coil and a collector coil that are physically separated from each other, a method of manufacturing the same.

### Background of the Related Art

In order to drive a semiconductor switching element such as an IGBT or MOSFET used for power conversion, a switch driving device (circuit) that can control a gate voltage of the IGBT or MOSFET is used.

In general, an electrical reference potential of a switch driving circuit is connected to a potential of a source of the semiconductor switching element. Depending on the on/off state of the switch, the source potential of the switching element may change rapidly. Therefore, the switch driving circuit requires an independent isolation voltage.

An isolation voltage source supplied to a conventional switching driving circuit is supplied through a DC/DC converter using an isolation transformer. The transformer used here has a parasitic capacitance occurring between primary and secondary transformer windings (or patterns of PCBs that act as windings of a general transformer) with a transformer core therebetween, and the parasitic capacitance acts as a path through which a common mode current flows due to a common mode voltage between primary and secondary voltages of the transformer.

The common mode current may cause a distortion of a signal that drives a semiconductor switching element in a switch driving circuit. The distortion of the switching signal may cause a malfunction of the semiconductor switching element, which may damage the semiconductor switching element.

With a recent advancement of power semiconductor technologies, the commercialization of SiC semiconductor switching elements has been rapidly progressed. The SiC semiconductor switching elements have characteristics such as a high withstand voltage and a low conduction resistance compared to conventional Si semiconductor switching elements. Therefore, SiC semiconductor switching elements have very good characteristics compared to Si semiconductor switching elements in terms of switching loss and conduction loss.

However, the high-speed switching characteristics of SiC semiconductor switching elements result in high voltage change rate per unit time (high dV/dt characteristics), which appears as a disadvantage in terms of the driving circuit of the SiC semiconductor element in that a large amount of common mode current can flow through the parasitic capacitance between the primary and secondary windings mentioned above.

In order to reduce the common mode current in the switch driving circuit, the parasitic capacitance seen across the primary and secondary sides of the isolation transformer must be minimized. Therefore, many studies have been published on transformer design to reduce parasitic capacitors on the primary and secondary sides of the transformer.

The most common method of reducing a parasitic capacitance of an isolation transformer for supplying an isolation voltage in a switch driving circuit that drives a semiconductor switching element is to maximize a spacing between primary and secondary windings and a transformer core. An area between the windings and the core is reduced, and a distance between the primary and secondary windings is also designed to be as large as possible.

This approach inevitably results in an increase in a size of the isolation transformer, and the increase in the size of the transformer increases a size of the switch driving circuit, which is disadvantageous in terms of cost and system reliability.

### SUMMARY OF THE INVENTIVE CONCEPT

The present disclosure is contrived to solve the foregoing problems, and

An aspect of the present disclosure is to supply insulated power required for switch driving of a 25 kV medium voltage system by securing a high insulation strength at a medium voltage, that is, a level of 70 kV, by using a feed coil and a collector coil that are physically separated from each other.

Another aspect of the present disclosure is to manufacture an insulating structure of a feed coil and a collector coil through epoxy molding and conductive paint application to concentrate the intensity of an electric field into the insulating structure so as to implement a reduction in size and weight.

A wireless power supply device for switch driving of a medium voltage system according to the present disclosure may include a high frequency conversion unit for converting input power into AC power; a feed coil connected to the high h frequency conversion unit to generate AC power into an AC magnetic field; a first insulating structure surrounding the feed coil; a collector coil spaced apart from the feed coil by a predetermined distance to generate AC power by an AC magnetic field radiated from the feed coil; a second insulating structure surrounding the collector coil; and a power conversion unit connected to the collector coil to rectify and convert AC power into DC power, wherein the first and second insulating structure includes a first molding portion that surrounds the feed coil and the collector coil with an insulating material, and a first conductive coating layer applied by a conductive material on a surface of the first molding portion.

According to the present disclosure, the power supply coil and the collector coil may include a first and second core having an ‘I’-shape, and a first and second coil wound around the first and second core, wherein the first and second core is configured with one of a ferrite core, an iron core, and a magnetic powder core, and the first and second coil is configured with a Litz wire or magnet wire.

According to the present disclosure, a gap between the feed coil and the collector coil may be 2 cm.

According to the present disclosure, a first and second extractor for connecting the feed coil and the high frequency conversion unit, and connecting the collector coil and the power conversion unit may be molded into the first molding portion of the first and second insulating structure.

According to the present disclosure, the second insulating structure may further include a second molding portion that surrounds a first molding portion of the collector coil to extend the second extractor of the collector coil, wherein a surface of the second molding portion includes a second conductive coating layer formed by applying a conductive material.

According to the present disclosure, the second molding portion may be further provided with a support member for supporting the second extractor of the collector coil.

According to the present disclosure, the second insulating structure may further include a third molding portion connected to the second molding portion and formed along a length of the second extractor of the collector coil.

According to the present disclosure, an end of the third molding portion may be further provided with a copper plate to expose the second extractor of the collector coil.

According to the present disclosure, an end of the third molding portion may be further provided with a fixed wing portion that is unfolded to both sides thereof.

On the other hand, a method of manufacturing a wireless power supply device through forming a first and second insulating structure for a feed coil and a collector coil according to the present disclosure may include (a) a first mold step for forming a first molding n that surrounds the feed coil and the collector coil with an insulating material; (b) a first coating step for forming a first conductive coating layer by applying a conductive material to a surface of the first molding portion of the feed coil and the collector coil; (c) a second mold step S300 for forming a second molding portion that extends a second extractor coupled to the collector coil, and surrounds the first molding portion with an insulating material; (d) a second coating step for forming a second conductive coating layer by applying a conductive material to a surface of the second molding portion; and (e) a third mold step for connecting an insulating material to the second molding portion, and forming a third molding portion along a length of the second extractor.

According to the present disclosure, a copper plate may be further provided at an end of the third molding portion to expose the second extractor of the collector coil.

A wireless power supply device for switch driving of a medium voltage system and a method of manufacturing the same may supply insulated power required for switch driving of a 25 kV medium voltage system by securing a high insulation strength at a medium voltage, that is, a level of 70 kV, by using a feed coil and a collector coil that are physically separated from each other.

Furthermore, according to the present disclosure, an insulating structure of a feed coil and a collector coil may be manufactured through epoxy molding and conductive paint application to concentrate the intensity of an electric field into the insulating structure so as to implement a reduction in size and weight.

In addition, according to the present disclosure, the operating frequency may be increased to 2 MHz to increase the output power to 100 W.

Moreover, according to the present disclosure, a low parasitic capacitance between a feed coil and a collector coil causes almost no common mode current to be generated in a power supply device.

### BRIEF DESCRIPTION OF THE DRAWINGS

FIG. 1 is a conceptual diagram showing a wireless power

supply device for switch driving of a medium voltage system according to the present disclosure.

FIG. 2 is a circuit diagram showing a wireless power supply device according to the present disclosure.

FIG. 3 is a perspective view showing a feed coil and a collector coil of a wireless power supply device according to the present disclosure.

FIG. 4 is a flowchart showing a method of manufacturing an insulating structure of a feed coil and a collector coil of a wireless power supply device according to the present disclosure.

FIG. 5 is a process diagram showing a process of manufacturing an insulating structure of a feed coil and a collector coil of a wireless power supply device according to the present disclosure.

FIG. 6 is a detailed drawing showing an insulating structure of a wireless power supply device according to the present disclosure.

FIG. 7 is a drawing showing an electric field simulation of an insulating structure of a wireless power supply device according to the present disclosure.

### DETAILED DESCRIPTION OF THE PREFERRED EMBODIMENT

Hereinafter, preferred embodiments of the present disclosure will be illustrated and referred to so as to describe the present disclosure, operating advantages thereof, and objectives to be achieved by the implementation of the present disclosure.

First, the terms used herein are only used to describe specific embodiments and are not intended to limit the present disclosure, and a singular expression may include a plural expression unless clearly defined otherwise in the context. In addition, the term “include” or “have” used herein should be understood that they are intended to indicate the presence of a feature, a number, a step, an element, a component or a combination thereof disclosed in the specification, and it may also be understood that the presence or additional possibility of one or more other features, numbers, steps, elements, components or combinations thereof are not excluded in advance.

In describing the present disclosure, a detailed description of known related configurations and functions will be omitted to avoid unnecessarily obscuring the subject matter of the present disclosure.

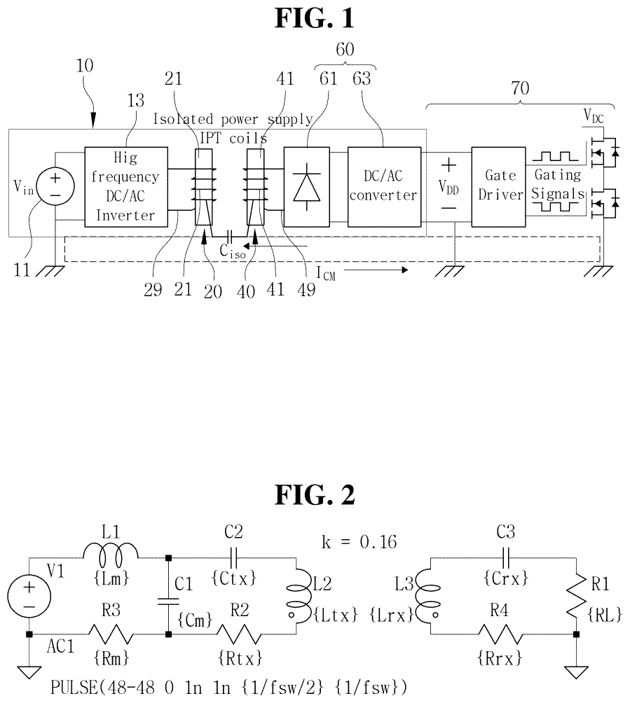

As shown in FIGS. 1 to 3 and FIG. 6, a wireless power supply device for switch driving of a medium voltage system according to the present disclosure is configured to include a high frequency conversion unit 10, a feed coil 20, a first insulating structure 30, a collector coil 40, a second insulating structure 50, and a power conversion unit 60.

First, the wireless power supply device may be broadly divided into a wireless power transmission side configured with the high frequency conversion unit and the feed coil 20, and a wireless power reception side configured with the collector coil 40 and the power conversion unit 60.

Wireless power generated from the wireless power reception side may be output as a driving voltage by a switch driving unit 70 through the wireless power receiving side.

That is, on the wireless power transmission side, the high frequency conversion unit 10 converts a DC voltage from an input power source 11 into an AC voltage to generate a transmission-side AC voltage, and the feed coil 20 generates an AC magnetic field.

In this manner, the AC magnetic field generated from the wireless power transmission side is transmitted to the wireless power reception side.

The collector coil 40 on the wireless power reception side generates wireless power from the AC magnetic field radiated from the feed coil 20. In this manner, wireless power generated from the collector coil 40 is converted from an AC voltage to a DC voltage through a power conversion unit, that is, a rectifier 61, and the DC voltage is stepped up or down through a DC/DC converter 63.

The switch driving unit 70 may output a DC voltage on the power reception side as a driving voltage V_{DD} in response to a control signal supplied from the outside.

As described above, according to the present disclosure, there is provided a wireless power supply device having an insulation strength of 70 kV, and as shown in FIG. 1, an input voltage (Vᵢₙ) is 48 Vdc, which is converted into a high frequency alternating current using the high frequency conversion unit 10 (high frequency DC/AC inverter 13) that switches at 2 MHz. The feed coil 20 is connected to the high frequency conversion unit 10, and power is transmitted to the collector coil 40 spaced apart by 2 cm using a high frequency current generated by the high frequency conversion unit 10.

In this case, power may be transmitted up to 100 W. The rectifier 61 of the power conversion unit 60 is connected to the collector coil 40 to convert a 2 MHz alternating current (AC) into a direct current (DC), and the DC/DC converter 63 of the power conversion unit 60 is connected to the output to maintain a constant voltage.

The wireless power supply device may be used as a power source for switch driving in a medium voltage system. A design having a high insulation strength is enabled by using the feed coil 20 and the collector coil 40 that are physically separate from each other. In addition, a parasitic capacitance Ciso between the feed coil 20 and the collector coil 40 is very small, and a common mode current Icm flowing through the parasitic capacitance is also hardly generated.

FIG. 2 is a wireless power transmission circuit diagram for transmitting power to the feed coil 20 and the collector coil 40 that are spaced apart by 2 cm according to a wireless power supply device according to the present disclosure.

The input power source 11 is a high frequency AC/DC inverter 13 that converts 48 Vdc into 2 MHZ AC, and Ltx and Lrx are the self-inductances of the feed coil 20 and the collector coil 40. k, which is a coupling coefficient between the feed coil 20 and the collector coil 40, may have a value of approximately 0.16 at a gap of 2 cm.

Lm, Cm, and Ctx may be additionally connected to the feed coil 20 as a resonant circuit, and Crx may be additionally connected to the collector coil 40 as a resonant circuit. Rtx, Rrx, and Rm are parasitic resistances of the feed coil 20, the collector coil 40, and a compensation circuit, respectively, and RL is an equivalent load resistance.

Circuit parameters designed in the present disclosure are as follows.

Ltx=6.5 μH, Ctx=974 pF, Rtx=0.15 Ω, Lrx=4.2 μH, Crx=1.5 nF, Rrx=0.06 Ω, Lm=1.2 μH, Cm=5 nF, Rm=0.1 Ω, RL=7.3 Ω

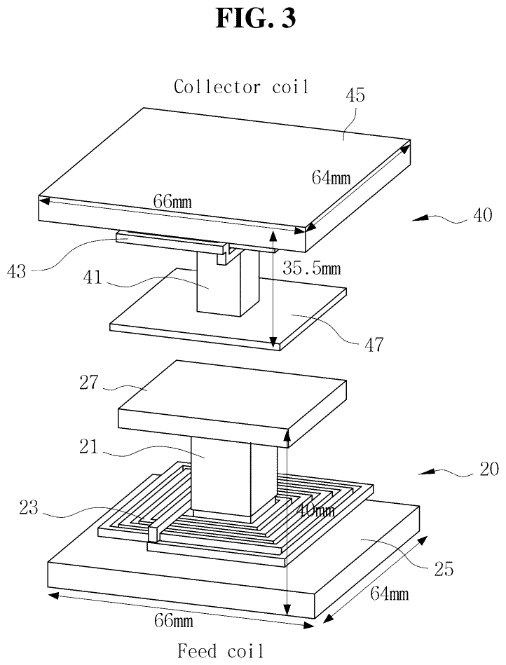

The feed coil 20 and the collector coil 40 according to the present disclosure may be manufactured as shown in FIG. 3.

First, the feed coil 20 is configured with a first core 21 in the shape of a square pillar, a first flange portion 25 connected to a bottom of the first core 21, and a second flange portion 27 connected to a top of the first core 21. Therefore, the feed coil 20 is configured with an ‘I’ shaped core. Therefore, the feed coil 20 is configured with an ‘I’ shaped core.

In addition, the feed coil 20 includes a first coil 23 wound on a bottom of the first core 21.

Next, the collector coil 40 may also be an ‘I’ shaped core configured with a second core 41, a third flange portion 45, and a fourth flange portion 47, similar to the feed coil 20.

In addition, the collector coil 40 is configured to include a second coil 43 wound on a top of the second core 41.

In this case, the ‘I’ shaped core of the feed coil 20 and the collector coil 40 may be configured with any one of a ferrite core, an iron core, and a magnetic powder core (powder core). In this case, in the case of the ferrite core, it may be manufactured with 3F46, which provides excellent performance in an range of 1 MHZ to 3 MHZ suitable for 2 MHZ operation.

Additionally, the first and second coils 23, 43 may each be wound with a Litz wire or magnet wire.

Here, the Litz Wire, which is a copper wire made by twisting several strands of an ultra-fine enamel-coated wire (diameter; 0.04 mm/0.05 mm, etc.) at a constant pitch, is a wire used in high-frequency devices.

The Litz wire has a small increase in AC resistance due to a high frequency to suppress temperature rise in the coil, and is very flexible to provide good winding workability. There is also a wide range of options depending on the type of wire (a total length of wire, a soldering length, etc.). The twist pitch, diameter, and number of wires may be arbitrarily selected, and ends of the wires are soldered to a predetermined length with lead-free solder to improve workability.

For the specific dimensions of the feed coil 20 and the collector coil 40 configured as described above, the first flange portion 25 of the feed coil 20 and the third flange portion 45 of the collector coil 40 have the same horizontal and vertical lengths of 66 mm and 64 mm, respectively. However, a height of the feed coil 20 (length from the first flange portion 25 to the second flange portion 27) is 40 mm, and a height of the collector coil 40 (length from the fourth flange portion 47 to the third flange portion 45) is 35.5 mm, which are different from each other.

Moreover, as described above, a gap, i.e., an air gap, between the feed coil 20 and the collector coil 40 is 2 cm.

In this case, the first flange portion 25 of the feed coil 20 and the third flange portion 45 of the collector coil 40 have cross-sectional areas larger than those of the first and second cores 21, 41, respectively. Accordingly, the first and third flange portions 25, 45 may physically fix a transmission-side core and a reception-side core, respectively, and perform various electromagnetic roles such as reducing parasitic capacitance and increasing power transmission efficiency.

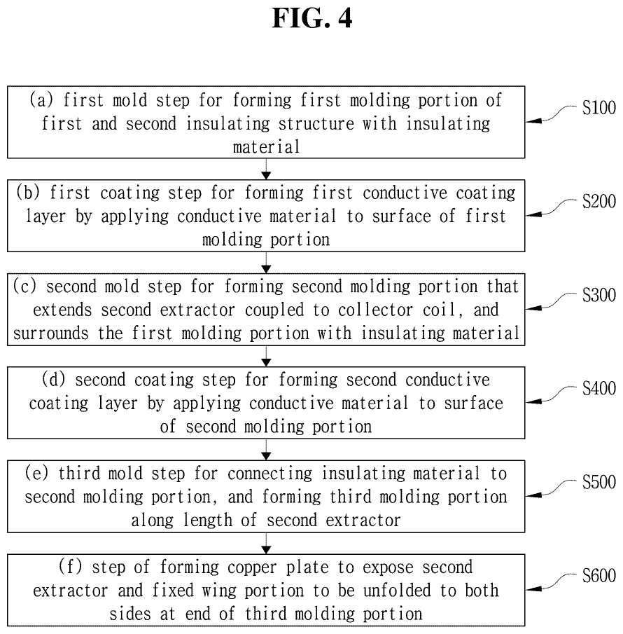

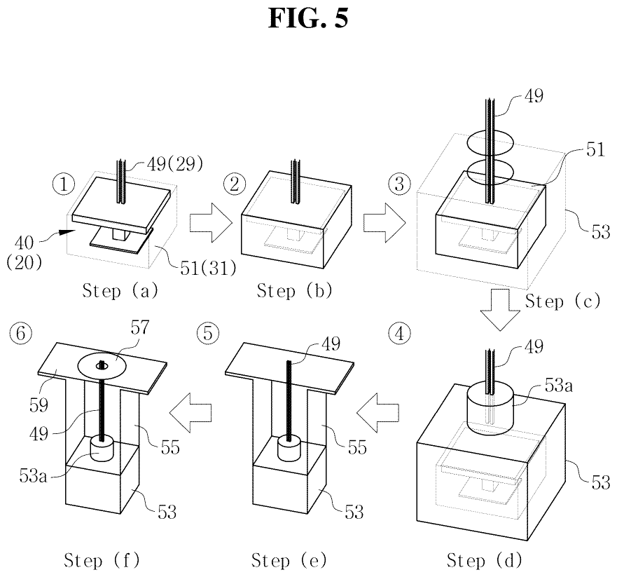

The illustrations in FIGS. 4 and 5 show a method and process of manufacturing an insulating structure in a wireless power supply device according to the present disclosure.

First, as shown in FIG. 4, a method of manufacturing a wireless power supply device according to the present disclosure, that is, a method of manufacturing an insulating structure, is as follows.

That is, step (a) S100 is a first mold step for forming a first molding portion 31, 51 that surrounds the feed coil 20 and the collector coil 40 with an insulating material, respectively (see (a) of FIG. 5). In this case, the first extractor 29 of the feed coil 20 is exposed to the first molding portion 31 to be connected to the high frequency conversion unit 10, and the second extractor 49 of the collector coil 40 is exposed to the first molding portion 51. In this manner, the first molding portions 31, 51 of the first and second insulating structures 30, 50 are formed.

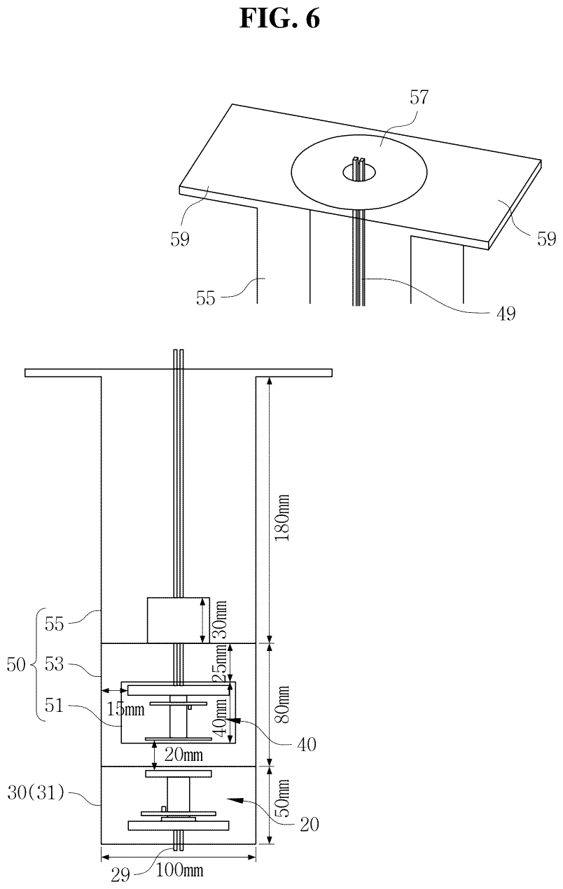

In this case, as shown in FIG. 6, the first molding portion 31 of the collector coil 20 may be manufactured to have a horizontal and vertical length of 100 mm and a height of 50 mm. In addition, the first molding portion 51 of the collector coil 40 may be manufactured to have a horizontal and vertical length of 70 mm and a height of 40 mm.

Step (b) S200 is a first coating step for forming a first conductive coating layer by applying a conductive material to a surface of the first molding portion 31, 51 of the feed coil 20 and the collector coil 40 (see (b) of FIG. 5).

Subsequent to performing the first mold step and the first coating step in this manner, the feed coil 20 is grounded to 0 V and the collector coil 40 is grounded to a high voltage. In this case, the manufacture of the first insulating structure 30 for the feed coil 20 is completed.

Subsequently, steps (c) S300 to (f) S600 are processes for manufacturing the second insulating structure 50 for the collector coil 40.

Step (c) S300 is a second mold step for forming a second molding portion 53 that extends a second extractor 49 coupled to the collector coil 40, and surrounds the first molding portion 51 with an insulating material (see (c) of FIG. 5). Here, a cylindrical support member 53a may be preferably formed on an upper portion of the second molding portion 53 to support a bottom portion of the second extractor 49 of the collector coil 40 so as to allow the second extractor 49 to be stably disposed.

In this case, as shown in FIG. 6, the first molding portion 53 may be manufactured to have a horizontal and vertical length of 100 mm and a height of 80 mm. In particular, the first molding portion 51 of the second insulating structure 50 may be configured not to be in contact with the second molding portion 53, and may be manufactured such that a lower portion thereof is in a floating state to maintain a gap of 2 cm between the feed coil 20 and the collector coil 40, and to maintain a separation distance of 25 mm from an upper surface of the first molding portion 51 to an upper surface of the second molding portion 53. In addition, the support member 53a disposed on an outer upper surface of the second molding portion 53 may be manufactured to have a height of 30 mm.

Step (d) S400 is a second coating step for forming a second conductive coating layer by applying a conductive material to a surface of the second molding portion 53 (see (d) of FIG. 5). Subsequent to performing the second mold step and the second coating step in this manner, the collector coil 40 is grounded to 0 V.

Step (e) S500 is a third mold step for connecting an insulating material to the second molding portion 53 and forming a third molding portion 55 along a length of the second extractor 49 (see (e) of FIG. 5). That is, the third molding portion 55 is formed in a box shape by extending from a top of the second molding portion 53, and may be formed such that a height of the third molding portion 55 from an upper surface of the second molding portion 53 is above 180 mm as shown in FIG. 6. In addition, a horizontal and vertical length of the third molding portion 55 may each be manufactured to be 100 mm.

As described above, when the molding of the first to third molding portions 51, 53, 55 of the second insulating structure 50 is completed, step (f) S600 is performed to install a copper plate member 57 and a fixed wing portion 59 that is unfolded outward from an end of the third molding portion 55 so as to expose the second extractor 49 of the collector coil 40 at a top, that is, an end of the third molding portion 55.

When going through steps (S100 to (f) S600 as described above, the manufacture of the first insulating structure 30 for the feed coil 20 and the second insulating structure 50 for the collector coil 40 may be completed.

In particular, the first and second insulating structures 30, 50 according to the present disclosure be preferably manufactured from an insulating material such as epoxy.

The insulating structure according to the present disclosure, which is an insulating structure applied to a wireless power supply device for switch driving of a 25 kV medium voltage system for railway vehicles, is an insulating structure of a wireless power supply device having an insulation strength of 70 kV.

To this end, the insulating structure of the wireless power supply device is an insulating structure for preventing insulation breakdown caused by a high electric field in an air layer by using epoxy molding having a high insulation strength and a conductive coating layer coated with conductive paint to prevent leakage of an electric field, and reducing an insulation distance between modules in the wireless power supply device. This allows the volume and weight of the system to be reduced to implement a reduction in size and weight of the device.

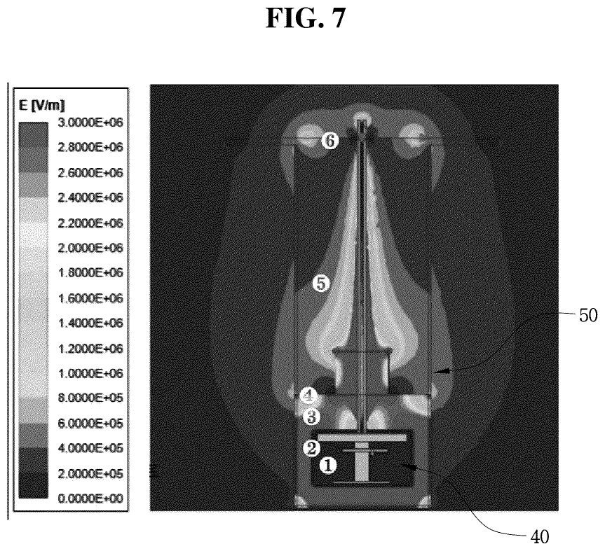

FIG. 7 is a result of simulating an insulation strength of the insulating structure manufactured as described above.

That is, when a potential difference between the feed coil 20, which is a high voltage side, and the collector coil 40, which is a lower voltage side, is 70 kV, an electric field is concentrated into epoxy, which is an insulating structure. It can be seen that an electric field strength outside the insulating structure is less than 3 MV/m, which is lower than the dielectric strength of air, and thus, insulation breakdown does not occur even when air is present.

The wireless power supply device for switch driving of a medium voltage system according to the present disclosure configured as described above may achieve the following advantages.

First, the operating frequency may be increased to 2 MHZ to increase the output power to 100 W, and allow a reduction in size and weight.

Second, an insulation strength may be secured at a level of 70 kV so as to be used as insulated power required for switch driving of a 25 kV system.

Third, a low parasitic capacitance between the feed coil 20 and the collector coil may cause almost no common mode current to be generated in a wireless power supply device.

Fourth, the intensity of an electric field intensity may be concentrated into the insulator through epoxy molding and conductive paint application so as to reduce a size of the insulating structure.

As described above, the present disclosure has been described with reference to an embodiment illustrated in the drawings, but the embodiment is merely illustrative, and is not limited to the above-described embodiments, and it should be appreciated by those skilled in the art that various modifications and other embodiments equivalent thereto can be made therefrom.

Therefore, the true technical protective scope of the present disclosure should be determined based on the technical concept of the appended claims.

What is claimed is:

1. A wireless power supply device for switch driving of a medium voltage system, the device comprising:
a high frequency conversion unit for converting input power into AC power;
a feed coil connected to the high frequency conversion unit 10 to generate AC power into an AC magnetic field;
a first insulating structure surrounding the feed coil;
a collector coil spaced apart from the feed coil by a predetermined distance to generate AC power by an AC magnetic field radiated from the feed coil;
a second insulating structure surrounding the collector coil; and
a power conversion unit connected to the collector coil to rectify and convert AC power into DC power,
wherein the first and second insulating structure comprises:
a first molding portion that surrounds the feed coil 20 and the collector coil 40 with an insulating material; and
a first conductive coating layer applied by a conductive material on a surface of the first molding portion.

2. The device of claim 1, wherein the power supply coil and the collector coil comprise:
a first and second core having an ‘I’-shape, and
a first and second coil wound around the first and second core,
wherein the first and second core is configured with one of a ferrite core, an iron core, and a magnetic powder core, and
wherein the first and second coil is configured with a Litz wire or magnet wire.

3. The device of claim 1,
wherein a gap between the feed coil and the collector coil is 2 cm.

4. The device of claim 1, wherein a first and second extractor for connecting the feed coil and the high frequency conversion unit, and connecting the collector coil and the power conversion unit is molded into the first molding portion of the first and second insulating structure.

5. The device of claim 4, wherein the second insulating structure further comprises a second molding portion that surrounds a first molding portion of the collector coil to extend the second extractor of the collector coil, and
wherein a surface of the second molding portion comprises a second conductive coating layer formed by applying a conductive material.

6. The device of claim 5, wherein the second molding portion is further provided with a support member for supporting the second extractor of the collector coil.

7. The device of claim 6, wherein the second insulating structure further comprises a third molding portion connected to the second molding portion and formed along a length of the second extractor of the collector coil.

8. The device of claim 7, wherein an end of the third molding portion is further provided with a copper plate member to expose the second extractor of the collector coil.

9. A method of manufacturing a wireless power supply device through forming a first and second insulating structure for a feed coil and a collector coil, the method comprising:
(a) a first mold step S100 for forming a first molding portion that surrounds the feed coil 20 and the collector coil with an insulating material;
(b) a first coating step S200 for forming a first conductive coating layer by applying a conductive material to a surface of the first molding portion 31, 51 of the feed coil 20 and the collector coil;
(c) a second mold step S300 for forming a second molding portion that extends a second extractor coupled to the collector coil, and surrounds the first molding portion with an insulating material;
(d) a second coating step S400 for forming a second conductive coating layer by applying a conductive material to a surface of the second molding portion 53; and
(e) a third mold step S500 for connecting an insulating material to the second molding portion, and forming a third molding portion along a length of the second extractor.

10. The method of claim 9, wherein a copper plate member is further provided at an end of the third molding portion to expose the second extractor of the collector coil.
